(19) United States
(12) Patent Application Publication
(10) Pub. No.: US 2004/0186949 A1
(43) Pub. Date: Sep. 23, 2004

(54) XIP system and method for serial memory

(75) Inventors: Chien-Hsing Liu, Shinjuang City (TW); Cheng-Han Chang, Taoyuan (TW)

Correspondence Address: LADAS & PARRY, 5670 WILSHIRE BOULEVARD, SUITE 2100, LOS ANGELES, CA, 90036-5679, US

(73) Assignee: ICP Electronics Inc.

(21) Appl. No.: 10/444,572

(22) Filed: May 22, 2003

(30) Foreign Application Priority Data
Mar. 20, 2003 (TW) 92106139

(51) Int. Cl. G06F 12/00

(52) U.S. Cl. 711/104

(57) ABSTRACT

An XIP system and method for serial memory used between a host and the serial memory are described. The XIP system receives information including at least an access signal and a parallel access address from the host, transforms the parallel access address into a serial access address, and generates a serial command according to the access signal. The serial command and the serial access address are combined into a serial data combination and the serial data combination is then transmitted to the serial memory. After receiving the serial data combination, the serial memory performs access operations according to the serial data combination.

### BACKGROUND OF THE INVENTION

1. Field of the Invention

The present invention relates to an access system and method for serial memory, and particularly to an execute-in-place (XIP) system and method for the serial memory that enables a serial Non-Volatile Random Access Memory (NVRAM) to store parallel data from a host, and allows the host to execute directly program codes in the serial NVRAM.

2. Description of the Related Art

There are two types of memory, classified by access type, including parallel/NOR type memory and serial/NAND type memory. The access rate of parallel memory is higher than that of serial memory since the parallel memory can be accessed via a parallel output/input interface. Further, since parallel memory allows the host to access the minimum unit (byte) of the memory, the parallel memory is always adopted as the system memory for computer systems and is used to store program data. The computer systems are therefore able to perform XIP in the parallel memory.

FIG. 1 is a schematic diagram of a conventional access of parallel memory. To write data into parallel memory 13, the central processing unit (CPU) 10 sends a writing signal to parallel memory 13 via a control circuit 11, and transmits a writing address and data to the parallel memory 13 via an address/data bus 12. After that, the data is written into memory cells of the parallel memory 13 according to the writing signal and the writing address. To read program data from the parallel memory 13, the CPU 10 sends a reading signal to the parallel memory 13 via the control circuit 11, and transmits a reading address to parallel memory 13 via the address/data bus 12. The parallel memory 13 then reads the program data according to the reading signal and the reading address, and transmits the program data to the CPU 10.

The serial memory, such as data flash memory and a hard disc, is always used to back up data. However, the serial memory cannot allow the host to perform XIP and the serial memory is also called non-XIP memory since the access units of the serial memory are defined as blocks.

Since the parallel memory is parallel accessed, many insertions and extractions are required of access pins of parallel memory, and malfunctions may occur at the contact points. Further, delay between access pins will be serious if the speed of the CPU is increased. The resources of the CPU for controlling the signals in synchronization are thus wasted. In addition, with the development of serial memory, the capacity of the serial memory has increased, while the prices of the serial memory have fallen. As a result, the serial memory replaces the parallel memory for an important advance of next generation computer systems and allow hosts to perform XIP therein.

### SUMMARY OF THE INVENTION

It is therefore an object of the present invention to provide an XIP system and method for serial memory that directly stores data and executes program codes in serial format in the serial memory according to messages in parallel format from a host.

To achieve the above object, the present invention provides an XIP system and method for serial memory to receive information including at least an access signal and a parallel access address from a host. The XIP system transforms the parallel access address into a serial access address and generates a serial command according to the access signal thereto. The serial command and the serial access address are then combined into serial data combination, and the serial data combination is transmitted to the serial memory. After receiving the serial data combination, the serial memory performs access operations according to the serial data combination.

If the access signal is a reading signal, the serial command generated by the XIP system is a serial reading command, thereby enabling the serial memory to read first serial data therein according to the serial access address, and transmit the first serial data back to the XIP system. The XIP system then transforms the first serial data into first parallel data, and transmits the first parallel data to the host.

If the access signal is a writing signal and the XIP system further receives second parallel data from the host, the serial command generated by the XIP system is a serial writing command. The XIP system transforms the second parallel data into second serial data, and combines the second serial data into the serial data combination, thereby allowing serial memory to write the second serial data according to the serial access address.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating a conventional access of parallel memory;

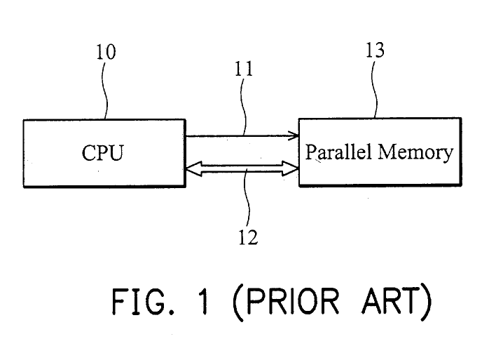

FIG. 2A is a schematic diagram illustrating the architecture of the XIP system for serial memory according to an embodiment of the present invention;

FIG. 2B is a schematic diagram illustrating the architecture of the XIP system for serial memory according to another embodiment of the present invention;

FIG. 3 is a flowchart showing the read process of the XIP method for serial memory according to the embodiment of the present invention; and

FIG. 4 is a flowchart showing the write process of the XIP method for serial memory according to the embodiment of the present invention.

### DETAILED DESCRIPTION OF THE INVENTION

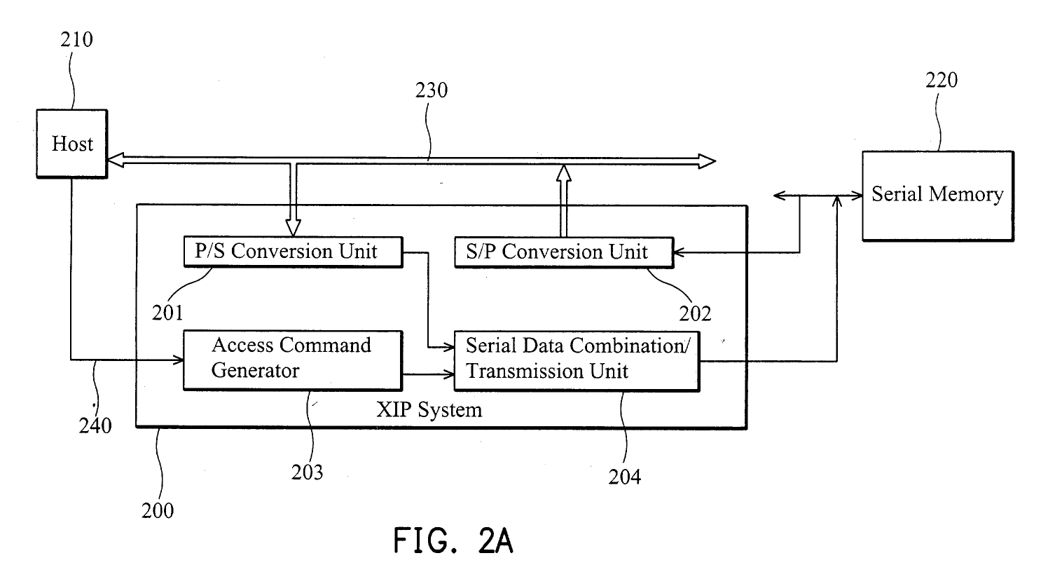

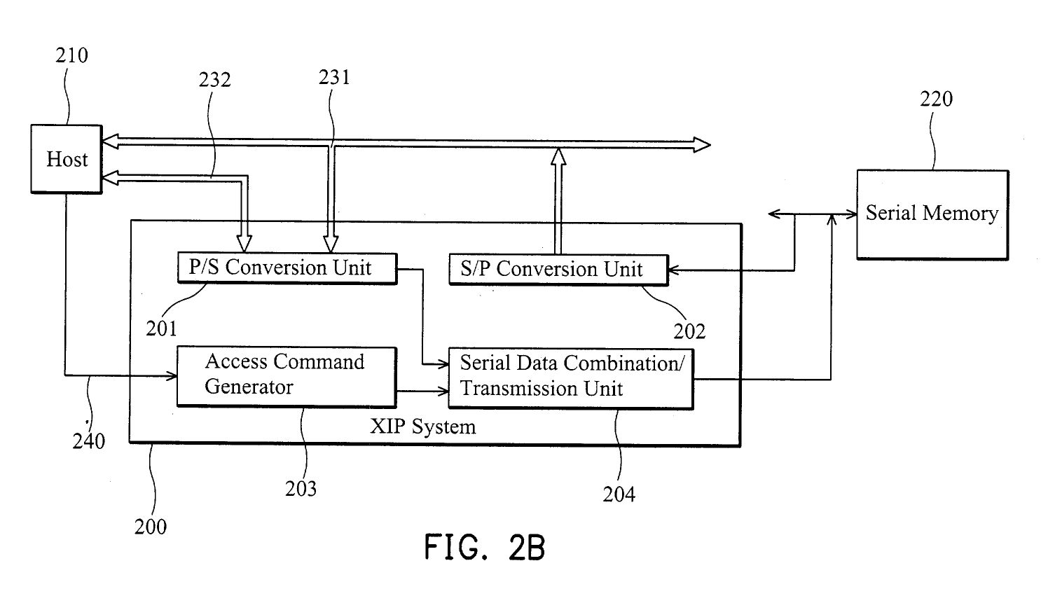

FIG. 2A illustrates the architecture of the XIP system for serial memory according to the embodiment of the present invention. The XIP system 200 allows a host 210 to access a serial memory 220. The serial memory 220 may be a NAND type of data storage media, such as a NVRAM. The XIP system 200 is a controller of serial memory 220.

The host 210 transmits an access signal to the XIP system 200 via a control circuit 240, and transmits address information and data to the XIP system 200 via an address/data bus 230, or receives data from the XIP system 200. FIG. 2B illustrates the architecture of the XIP system for serial memory according to another embodiment of the present invention. The difference between FIG. 2A and FIG. 2B is the architecture of address and data buses. In FIG. 2A, the address and data buses are constructed together. In FIG. 2B, an address bus 232 and a data bus 231 are constructed respectively between the host 210 and the XIP system 200. It should be noted that the present invention is not limited to a particular bus construction.

As shown in FIG. 2A, the XIP system 200 includes a Parallel/Serial (P/S) conversion unit 201, a Serial/Parallel (S/P) conversion unit 202, an access command generator 203 of the serial memory and a serial data combination/transmission unit 204.

The P/S conversion unit 201 receives a parallel access address from the host 210 via the address/data bus 230 and transforms the parallel access address into a serial access address recognized by the serial memory 220. It should be noted that for the host 210 to write parallel data with parallel format into serial memory 220, the host 210 further transmits the parallel data to the P/S conversion unit 201, and the P/S conversion unit 201 transforms the parallel data into serial data with serial format.

The access command generator 203 of serial memory receives the access signal from the host 210 via the control circuit 240, and generates a serial command according to the access signal, such as a serial reading command and a serial writing command enabling serial memory 220 to perform corresponding read and write operations respectively. It should be noted that the serial command may be a leading code recognized by the serial memory 220.

The serial data combination/transmission unit 204 combines the serial command, the serial access address, and/or the serial data into serial data combination, and transmits the serial data combination to serial memory 220. The serial memory 220 then performs related access operations according to the serial data combination.

After the access operations are finished and retrieved data is to be sent back to the host 210, the serial memory 220 transmits serial data with serial format to the S/P conversion unit 202 of the XIP system 200. The S/P conversion unit 202 transforms the serial data into parallel data with parallel format, and transmits the parallel data to the host 210.

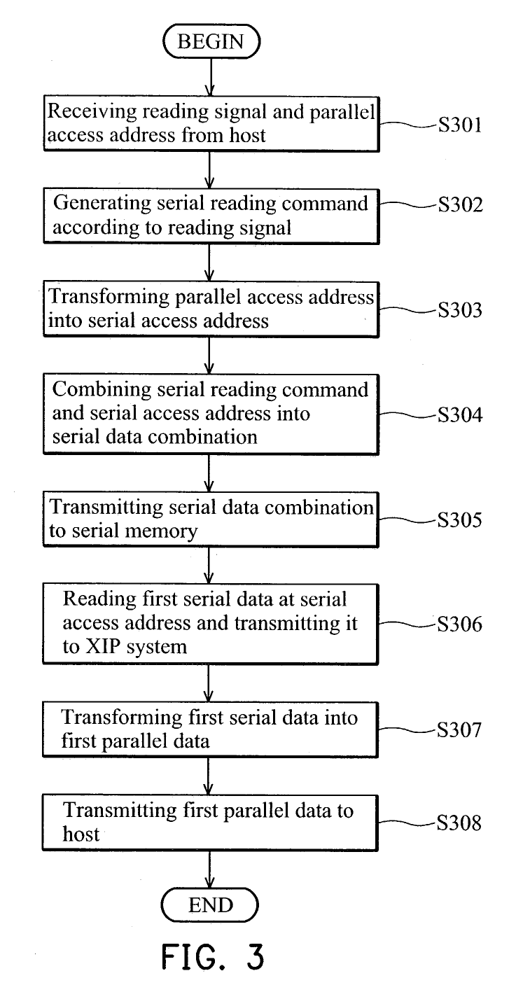

FIG. 3 shows the reading process of the XIP method for serial memory according to the embodiment of the present invention. For the host 210 to read information from serial memory 220, in step S301, the XIP system 200 receives a parallel access address and a reading signal. Then, in step S302, the access command generator 203 of the serial memory generates a serial reading command according to the reading signal, and in step S303, the P/S conversion unit 201 transforms the parallel access address into a serial access address.

Thereafter, in step S304, the serial data combination/transmission unit 204 combines the serial reading command generated by the access command generator 203 of the serial memory and the serial access address output by the P/S conversion unit 201 into serial data combination, and in step S305, transmits the serial data combination to serial memory 220.

After serial memory 220 receives the serial data combination, in step S306, serial memory 220 decodes the serial data combination, reads first serial data at the serial access address, and transmits the first serial data to the XIP system 200. Afterward, in step S307, the S/P conversion unit 202 transforms the received first serial data into first parallel data, and in step S308, transmits the first parallel data to the host 210.

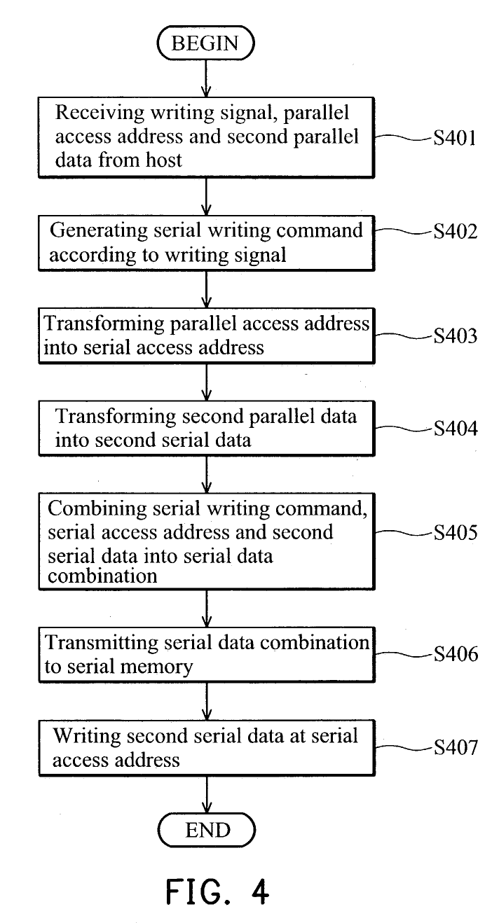

FIG. 4 shows the writing process of the XIP method for serial memory according to the embodiment of the present invention. For the host 210 to write information into serial memory 220, in step S401, the XIP system 200 receives information including a parallel access address, second parallel data, and a writing signal. Then, in step S402, the access command generator 203 generates a serial writing command according to the writing signal. Then, in step S403, the P/S conversion unit 201 transforms the parallel access address into a serial access address, and in step S404, the P/S conversion unit 201 transforms the second parallel data into second serial data.

Thereafter, in step S405, the serial data combination/transmission unit 204 combines the serial writing command, the serial access address and the second serial data into serial data combination, and in step S406, transmits the serial data combination to serial memory 220. After serial memory 220 receives the serial data combination, in step S407, serial memory 220 decodes the serial data combination, and writes the second serial data at the serial access address.

As a result, using the XIP system and method for serial memory, the program data can be stored in serial memory, and the host can execute program codes in serial memory directly. Thus the problems of delay between access pins and malfunctions at the contact points can be avoided, thereby providing a flexible XIP architecture for serial memory.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. An execute-in-place (XIP) system for serial memory used between a host and a serial memory, comprising:
an access command generator for the serial memory to receive an access signal from the host and generate a serial command according to the access signal;
a parallel/serial (P/S) conversion unit for receiving a parallel access address from the host and transforming the parallel access address into a serial access address; and
a serial data combination/transmission unit to combine the serial command and the serial access address into a serial data combination, and transmit the serial data combination to the serial memory, wherein the serial memory performs a data access operation according to the serial data combination.

2. The XIP system for serial memory as claimed in claim 1, wherein if the access signal is a reading signal, the serial command of the access command generator is a serial reading command so that the serial memory reads first serial data corresponding to the serial access address, and the first serial data is transmitted to the XIP system.

3. The XIP system for serial memory as claimed in claim 2, further comprising a serial/parallel (S/P) conversion unit to transform the first serial data into a first parallel data and the first parallel data is transmitted to the host.

4. The XIP system for serial memory as claimed in claim 2, wherein if the access signal is a writing signal, the host further transmits a second parallel data to the XIP system.

5. The XIP system for serial memory as claimed in claim 4, wherein the P/S conversion unit transforms the second parallel data into a second serial data and the second serial data are combined into the serial combination by the serial data combination/transmission unit.

6. The XIP system for serial memory as claimed in claim 5, wherein if the serial command is a serial writing command, the second serial data is written to the serial memory responsive to the serial access address.

7. An XIP method for serial memory in a host and the serial memory, the XIP method comprising the steps of:
receiving an access signal and a parallel access address from the host;
generating a serial command according to the access signal;
transforming the parallel access address into a serial access address;
combining the serial command and the serial access address into a serial data combination;
transmitting the serial data combination to the serial memory; and
performing a data access step according to the serial data combination received by the serial memory.

8. The XIP method for serial memory as claimed in claim 7, wherein if the access signal is a reading signal, the serial command is a serial reading command, and first serial data at the serial access address is read out by the serial memory and transmitted to the XIP system.

9. The XIP method for serial memory as claimed in claim 8, further comprising steps of transforming the first serial data into first parallel data and transmitting the first parallel data to the host.

10. The XIP method for serial memory as claimed in claim 7, further comprising step of receiving second parallel data from the host if the access signal is a writing signal.

11. The XIP method for serial memory as claimed in claim 10, further comprising steps of transforming the second parallel data into second serial data and combining the second serial data into the serial data combination.

12. The XIP method for serial memory as claimed in claim 11, wherein if the serial command is a serial writing command, the second serial data at the serial access address is written to the serial memory.
